(19) United States
(12) Patent Application Publication
(10) Pub. No.: US 2016/0340586 A1
(43) Pub. Date: Nov. 24, 2016

(54) FIRE RESISTANT MATERIAL

(71) Applicant: PILKINGTON GROUP LIMITED, LATHOM (GB)

(72) Inventors: MATTHIAS AUTH, ESSEN (DE); HELGA GRUENZEL, GELSENKIRCHEN (DE); CHRISTIAN OSLISLO, OBERHAUSEN (DE); ANDREAS POERSCH, GELSENKIRCHEN (DE)

(73) Assignee: PILKINGTON GROUP LIMITED, LATHOM (GB)

(21) Appl. No.: 14/392,406

(22) PCT Filed: Dec. 1, 2014
(86) PCT No.: PCT/GB2014/053568

§ 371 Date: May 26, 2016

(30) Foreign Application Priority Data
Nov. 29, 2013 (GB) 1321122.2
Apr. 29, 2014 (GB) 1407542.8
Jun. 26, 2014 (GB) 1411411.0

(51) Int. Cl. C09K 21/02; C09K 21/06; E06B 3/04; E04B 1/94; E06B 5/16; C09K 21/04; C09K 21/14

(52) U.S. Cl. CPC C09K 21/02; C09K 21/04; C09K 21/06; C09K 21/14; E04B 1/941; E06B 5/16; E06B 3/04

(57) ABSTRACT

A fire resistant composite material comprising: a matrix comprising one or more liquid and one or more of silicates of the elements of Groups 1, 2, 13 and/or 14 of the periodic table, phosphates of the elements of Group 13 of the periodic table and/or organo compounds of the elements of Group 13 of the periodic table; and a cooling agent comprising one or more of MOH, M₂O, M₂ SO₄, MHSO₄, M(PO₃)₃, MₓH₃₋ₓPO₄ (where x=0 to 3), M₂CO₃, MHCO₃, borates such as M₂ [B₄O₅(OH)₄](where M=Li, Na, K, and/or NH₄), M′(OH)₂, M′O, M′CO₃, M′SO₄, M′PO₄(where M′=Ca, Mg, Ba, Sr, and/or Fe), Al(OH)₃, Fe(OH)₃, Si(OH)₄, SiO(OH)₂, FeO(OH), AlO(OH), salts thereof, silica gel, molecular sieves, glycols, polyols, non-flammable organic solvents, dried alkali metal silicates and/or saccharides; and/or an isolating agent comprising one or more of hollow microspheres,foam microspheres, glass flakes, ceramic flakes, wood chips and/or cellulose chips.

This invention relates to a fire resistant material, a method for the preparation of said fire resistant material and the use of said fire resistant material. This invention also relates to inserts for fire resistant glazing frames that incorporate said material, and frames, buildings and assemblies that incorporate said inserts.

Fire resistant glass laminates incorporating an intumescent inorganic silicate interlayer sandwiched between two opposed panes of glass are marketed under the trade marks PYROSTOP and PYRODUR by the NSG Group. When such laminates are exposed to a fire the inorganic interlayer intumesces and expands forming a foam layer. The foam provides a thermally insulating layer which protects the pane of glass averted to the fire so that the structural integrity of the glass unit, which acts as a barrier preventing the propagation of the fire, is maintained for a longer period. Glass laminates incorporating such intumescent interlayers have been used successfully as fire resistant glass structures. These laminates may comprise more than two panes of glass sandwiching more than one intumescent interlayer. The intumescent inorganic layer is normally formed from a sodium silicate waterglass or a mixture thereof with potassium or lithium silicate waterglasses. The layer is commonly formed by preparing a solution of the silicate, spreading that solution on the surface of the glass and drying excess water from the solution so as to form the intumescent inorganic layer.

The framing system in which a fire resistant glazing is installed may incorporate one or more fire resistant inserts which are essential to the fire resistance performance of the entire system. To be precise, the frame must offer the same fire resistance as the glazing. However it is noted that a number of the currently available fire resistant inserts exhibit disadvantages such as low water stability, mechanical stability and form stability.

Low water stability means that the insert will change its dimensions over time when submerged in water, which might condensate in the frame due to high moisture content of the air. In every case, water soluble components such as salts and waterglass will transfer into the surrounding water. Several known inserts exhibit poor water stability because the matrix that is designed to assimilate the functional components is itself water soluble and therefore even insoluble components can be washed out.

Low form stability means that during manufacturing, in particular during drying processes, the insert will change its shape e.g. by bowing at the edges. This effect can also occur at standard atmospheric conditions if loss of water happens. In addition, if the alkali metal silicate content in the mixture is too high this can result in plastic behaviour while mechanically strained.

DE 102012220176 A1 describes a composition with at least two different water glasses and at least one further organic compound as a carbon donor including monohydric alcohols, polyhydric alcohols, carbohydrates, sugar alcohols, polyvinyl acetate, polyvinyl alcohols, ethylene oxide/propylene oxide polyols, and optionally their alkali metal salts. Independent claims are also included for: (1) a composite material comprising the above mentioned composition and at least one support material; (2) equipping the support materials with the composition, comprising providing the above mentioned composition, providing the support material, and contacting the above mentioned composition and the carrier material; (3) producing a moulded body, comprising (i) converting the above mentioned composition into a shape corresponding to an appropriate, desired moulded body, and (ii) exposing a preshaped composition obtained in the step (i) to energy; (4) the moulded body, obtainable by the above mentioned method; and (5) a use of at least one organic compound for improving the flexibility of intumescent compositions, for improving the swelling behaviour of intumescent compounds, and/or for improving the adhesion of intumescent compounds on substrates.

US 2014/0145104 A1 describes a thermally insulating fire-protection moulding containing at least one lightweight filler, one reaction product of the thermal curing of an organic-inorganic hybrid binder, one mineral that eliminates water, and also fibres and/or wollastonite.

It would be desirable to provide an improved fire resistant material that is structurally, chemically and aesthetically suitable to be used for inserts for fire resistant glazing systems such as frames, wall partitions, flooring, plates or filler bars in buildings. Such a material in the form of an insert would advantageously improve on the cooling performance of known materials and meet fire testing standards such as E130 or above. Additionally a temporary fluid mixture would be useful for pouring into a desired form and hardening over time.

According to a first aspect of the present invention there is provided a fire resistant composite material comprising: a matrix comprising one or more liquid and one or more of silicates of the elements of Groups 1, 2, 13 and/or 14 of the periodic table, phosphates of the elements of Group 13 of the periodic table and/or organo compounds of the elements of Group 13 of the periodic table; and

a cooling agent comprising one or more of MOH, M₂O, M₂SO₄, MHSO₄, M(PO₃)₃, MₓH₃₋ₓPO₄ (where x=0 to 3), M₂CO₃, MHCO₃, borates such as M₂[B₄O₅(OH)₄] (where M=Li, Na, K, and/or NH₄), M′(OH)₂, M′O, M′CO₃, M′SO₄, M′PO₄ (where M′=Ca, Mg, Ba, Sr, and/or Fe), Al(OH)₃, Fe(OH)₃, Si(OH)₄, SiO(OH)₂, FeO(OH), AlO(OH), salts thereof, silica gel, molecular sieves, glycols, polyols, non-flammable organic solvents, dried alkali metal silicates and/or saccharides; and/or

an isolating agent comprising one or more of hollow microspheres, foam microspheres, glass flakes, ceramic flakes, wood chips and/or cellulose chips.

According to a second aspect of the present invention there is provided a mixture for the preparation of a fire resistant composite material comprising:

a matrix comprising one or more liquid and one or more of silicates of the elements of Groups 1, 2, 13 and/or 14 of the periodic table, phosphates of the elements of Group 13 of the periodic table and/or organo compounds of the elements of Group 13 of the periodic table; and

a cooling agent comprising one or more of MOH, M₂O, M₂SO₄, MHSO₄, M(PO₃)₃, MₓH₃₋ₓPO₄ (where x=0 to 3), M₂CO₃, MHCO₃, borates such as M₂[B₄O₅(OH)₄] (where M=Li, Na, K, and/or NH₄), M′(OH)₂, M′O, M′CO₃, M′SO₄, M′PO₄ (where M′=Ca, Mg, Ba, Sr, and/or Fe), Al(OH)₃, Fe(OH)₃, Si(OH)₄, SiO(OH)₂, FeO(OH), AlO(OH), salts thereof, silica gel, molecular sieves, glycols, polyols, non-flammable organic solvents, dried alkali metal silicates and/or saccharides; and/or

an isolating agent comprising one or more of hollow microspheres, foam microspheres, glass flakes, ceramic flakes, wood chips and/or cellulose chips.

The inventor of the present invention has surprisingly established that the material of the first aspect provides improved fire resistance properties, particularly enhanced cooling performance, when incorporated into inserts for fire resistant systems such as glazing frames, doors, bulkheads, blinds and/or walls. The particular combination of the matrix, and cooling agent and/or isolating agent of this material affords structural and chemical stability alongside fire resistance performance that enables the material to be used for said inserts, wall partitions, flooring, plates or filler bars in buildings.

The matrix acts like a chemically stable glue in binding the various components of the material together. For instance, AlPO₄, Al(PO₃)₃, organoaluminium compounds, aluminium polyphosphate and/or Ca(OH)₂ may be reacted with an alkali metal silicate, such as a liquid waterglass, to form a stable silicate, preferably an aluminium silicate and/or a calcium silicate, which hardens the matrix and ensures that it is water stable i.e. the matrix does not change its dimensions over time when submerged in water.

The cooling agent works by using the heat energy of a fire to undergo an endergonic, preferably endothermal reaction. The reaction could involve the evaporation of a liquid such as water or the decomposition of a product for instance the conversion of aluminium hydroxide to water and aluminium oxide. The cooling effect could also come from other reactions that consume energy, especially heat energy, such as phase changes e.g. melting, salt solvation, crystal water release and other reactions.

The isolating agent controls the consumption of the cooling agent during a fire to help ensure that the cooling agent is gradually used up rather than being completely spent at the start of a fire. This is beneficial because, in the example of an insert for a fire resistant glazing frame, if there is not enough cooling agent present in the later stages of a fire the frame and glazing will fail and not meet the necessary fire test requirements which are indicative of minimum levels of protection for occupants. The isolating agent helps to reduce the heat transfer throughout the material to avoid the cooling agent being consumed in a short time period. Furthermore the isolating agent acts as a barrier to reduce the rate of loss of liquids and gases that may have a cooling effect e.g. water and water vapour. In some cases the isolating agent may possess an interlayered structure e.g. containing a layer of an insulator, followed by cavities with water or water vapour, followed by another layer of an insulator.

These various advantages enable the material of the present invention in the form of an insert to meet fire testing standards such as EI30 and above. In addition the material can be processed with commercial tools e.g. drills and cutters, does not shrink or undergoes minimal shrinkage over time, has high form stability over time, has good mechanical stability, undergoes minimum heat expansion, is form stable in water over time and has good stability against welding and powder coating.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

Preferably the mixture comprises at least 5% by weight of one or more liquid, more preferably at least 10% by weight, even more preferably at least 15% by weight, most preferably at least 20% by weight, but preferably at most 50% by weight of one or more liquid, more preferably at most 40% by weight, even more preferably at most 35% by weight, most preferably at most 30% by weight based on the total weight of the mixture. These preferred ranges ensure sufficient cooling effect without unacceptable loss of mechanical stability. These ranges also enable the one or more of phosphates and/or organo compounds of the elements of Group 13 of the periodic table, e.g. one or more aluminium phosphates and/or organoaluminium compounds, and/or compounds of the elements of Group 2 of the periodic table, e.g. Ca(OH)₂, to react with any alkali metal silicates at least to a degree in the desired manner. If the liquid content is too low, the reaction cannot occur because the aluminium phosphates and/or organoaluminium compounds do not dissolve enough. If the liquid content is too high, the reaction produces only small chained aluminium silicates rather than a sought after 3-dimensional network which enhances the hardness of the matrix. Typically the liquid is also a solvent for at least one component of the material and/or mixture. Preferably the one or more liquid comprises water.

Preferably the material comprises at least 3% by weight of one or more liquid, more preferably at least 7% by weight, even more preferably at least 10% by weight, most preferably at least 15% by weight, but preferably at most 50% by weight of one or more liquid, more preferably at most 35% by weight, even more preferably at most 30% by weight, most preferably at most 25% by weight based on the total weight of the material. These preferred ranges ensure sufficient cooling effect without unacceptable loss of mechanical stability. Preferably the one or more liquid comprises water.

In the context of the mixture or the material the one or more of silicates of the elements of Groups 1, 2, 13 and/or 14 of the periodic table, phosphates of the elements of Group 13 of the periodic table and/or organo compounds of the elements of Group 13 of the periodic table are preferably present at a total concentration of at least 2% by weight, more preferably at least 5% by weight, even more preferably at least 8% by weight, most preferably at least 10% by weight, but preferably at most 60% by weight, more preferably at most 40% by weight, even more preferably at most 25% by weight, most preferably at most 15% by weight based on the total weight of the mixture or the material. These preferred ranges ensure that the matrix provides sufficient support and room for the various other components that are present in the mixture and material.

Preferably the one or more phosphates and/or organo compounds of the elements of Group 13 of the periodic table have an average volume-based particle size (where the size of a given particle equals the diameter of the sphere that has the same volume as the given particle) of less than 5 mm, more preferably less than 2 mm, even more preferably less than 1 mm, even more preferably less than 0.5 mm, most preferably less than 0.25 mm. These preferred ranges are beneficial because a smaller particle size leads to a higher rate of reaction with alkali metal silicates. Particle size may be measured using a Malvern Mastersizer®.

Preferably the one or more silicates of the elements of Groups 1, 2, 13 and/or 14 of the periodic table comprise layer silicates e.g. wollastonites and/or zeolites, and/or comprise grog (chamotte), mullite and/or bentonite. Silicates of the elements of Groups 2, 13 and/or 14 of the periodic table, especially in the form of layer silicates, can also act as water and/or water vapour barriers to steadily control the effect of the cooling agent. The silicates of the elements of Group 1 of the periodic table (i.e. alkali metal silicates) may be lithium silicates, sodium silicates and/or potassium silicates. Preferably the silicates of the elements of Group 1 of the periodic table are potassium silicates. The silicates of the elements of Group 2 of the periodic table may be beryllium silicates, magnesium silicates and/or calcium silicates. Preferably the silicates of the elements of Group 2 of the periodic table are calcium silicates. Preferably the silicates of the elements of Group 13 of the periodic table are borosilicates and/or aluminium silicates. The silicates of the elements of Group 14 of the periodic table may be organosilicates. Preferably the phosphates of the elements of Group 13 of the periodic table are boron phosphates and/or aluminium phosphates such as AlPO₄, Al(PO₃)₃, aluminium polyphosphates, aluminium ortho-phosphates, and/or aluminium meta-phosphates. Aluminium phosphates may be prepared by reacting alkali (e.g. sodium-) phosphates or phosphoric acid with aluminium hydroxide. Preferably the organo compounds of the elements of Group 13 of the periodic table are organoboron and/or organoaluminium compounds. Aluminium silicates and alkaline earth metal silicates can act as thixotropic agents to ensure that the components of the mixture and material remain evenly distributed instead of separating out. The silicates of the elements of Group 1 of the periodic table (i.e. alkali-metal silicates) may comprise liquid and/or solid silicates. Preferably the silicates of the elements of Group 1 of the periodic table are dried silicates.

Preferably the one or more phosphates and/or organo compounds of the elements of Group 13 of the periodic table have sufficient solubility in the liquid, preferably water, such that they can react with components in the mixture such as silicates. Preferably the matrix has a pH greater than 7, more preferably greater than 9. Too little solubility means that the phosphates and/or organo compounds do not have chance to react, but too much solubility means that the compounds can react (and therefore harden) instantly which can make the mixture very difficult to handle.

In the context of the mixture or the material, in certain embodiments preferably the one or more silicates of the elements of Group 13 of the periodic table are present at a total concentration of at least 0.5% by weight, more preferably at least 1% by weight, even more preferably at least 2% by weight, most preferably at least 5% by weight, but preferably at most 50% by weight, more preferably at most 30% by weight, even more preferably at most 10% by weight, most preferably at most 8% by weight based on the total weight of the mixture or the material.

In the context of the mixture or the material, in certain embodiments preferably the one or more silicates of the elements of Group 1 of the periodic table (i.e. alkali metal silicates) are present at a total concentration of at least 1% by weight, more preferably at least 5% by weight, even more preferably at least 8% by weight, most preferably at least 10% by weight, but preferably at most 50% by weight, more preferably at most 30% by weight, even more preferably at most 20% by weight, most preferably at most 15% by weight based on the total weight of the mixture or the material. These preferred ranges provide sufficient mechanical stability whilst allowing for sufficient cooling agents.

In the context of the mixture or the material, in certain embodiments preferably the one or more silicates of the elements of Group 2 of the periodic table (i.e. alkaline earth metal silicates) are present at a total concentration of at least 0.1% by weight, more preferably at least 1% by weight, even more preferably at least 2% by weight, most preferably at least 5% by weight, but preferably at most 50% by weight, more preferably at most 30% by weight, even more preferably at most 10% by weight, most preferably at most 8% by weight based on the total weight of the mixture or the material. These preferred ranges allow for the desired levels of thixotropy, water stability and mechanical stability.

The matrix may further comprise one or more of Ca(Hal)₂, Mg(Hal)₂ (where Hal=F, Cl, Br, or I), aluminates, zinc compounds, zirconium compounds, titanium compounds, silica-sol, laponite; organic compounds such as polymers and/or polymer-containing substances such as acrylic acid/methacrylic acid copolymers, acrylates, e.g. styrene acrylates or other derivates, latex, vinyl-acetates, e.g. polyvinyl-acetate or derivates, polyvinyl polymers, polyethylene, polypropylene, PET, polyethanolate, polyurethane, polyesters, cotton, celluloses such as methyl cellulose and/or hydroxymethyl-cellulose, epoxy resins, phenolic resins, polycarboxylate ethers and/or nylon; paper preferably embedded with polymer wires, mesh, fabric, tapes and/or fibres of basalt, glass, ceramic, organic polymers, cotton and/or fibreglass; gauze bandages, siloxanes such as octamethylcyclotetrasiloxane (OMCTS), hexamethyldisiloxane (HMDSO), and/or tetraethyl orthosilicate (TEOS), and/or silicones. Aluminates and/or phosphates can react with an alkali metal silicate to afford water stability. Silica sols can react with an alkali metal silicate to form a transparent network which hardens the matrix. Zn, Zr and/or Ti-compounds (which may be introduced as organo-compounds, e.g. titanium acid esters, or as salts, e.g. ZnCl₂, ZrSO₄) can improve the chemical resistance of the matrix. Polymers can help stabilise the structure of the matrix, increasing its form- and mechanical-stability, can modify the rheology of the matrix (e.g. polycarboxylate ethers can act as liquefiers), can improve water stability and can enhance surface structure. The presence of polymers also makes the material easier to handle mechanically, for instance upon sawing the material less dust is produced and there is less of a tendency for the material to break and can improve the water stability. In some embodiments organic compounds, e.g. polymers, can form a stable foam, generating an intrinsic porosity by the encapsulation of gas, which can increase thermal insulation properties. Preferably said organic compounds are surfactants. During the production process, surfactants can form a stable foam that hardens over time, providing increased thermal insulation. Siloxanes and silicones can react with an alkali metal silicate to form a stable network.

In one embodiment in the context of the mixture or the material the polymers and/or polymer-containing substances are preferably present at a total concentration of at least 1% by weight, more preferably at least 3% by weight, even more preferably at least 4% by weight, most preferably at least 5% by weight, but preferably at most 40% by weight, more preferably at most 25% by weight, even more preferably at most 20% by weight, most preferably at most 15% by weight based on the total weight of the mixture or the material. Bearing in mind that polymers and polymer-containing substances may be flammable, these preferred ranges afford the corresponding benefits of the preceding paragraph without compromising on fire resistance. The polymers and/or polymer-containing substances of the material are preferably prepared in situ (i.e. in the mixture) by polymerisation of monomers and/or oligomers.

Preferably the matrix comprises both inorganic and organic components. Such a matrix may exhibit enhanced mechanical stability. The organic components may preferably comprise methyl cellulose, hydroxymethyl-cellulose and/or other cellulose derivatives. The methyl cellulose and/or other cellulose derivatives are preferably present at a total concentration of at least 1% by weight, more preferably at least 3% by weight, even more preferably at least 4% by weight, but preferably at most 15% by weight, more preferably at most 10% by weight, even more preferably at most 7% by weight, most preferably at most 5% by weight based on the total weight of the mixture or the material.

Preferably the matrix further comprises a mesh, fabric, tapes and/or fibres of 1) basalt, 2) glass, 3) ceramic, 4) organic polymers such as polypropylene and/or PET, 5) cotton and/or 6) fibreglass; materials derived from jute, flax, hemp and/or cellulose fibres, textile materials and/or gauze bandages. Basalt or glass mesh is fire resistant and provides excellent mechanical stability. The other above-named components, i.e. meshes, fabric, tapes and/or fibres also provide excellent reinforcement characteristics. The incorporation of the above-named components into the material provides the advantage of ensuring that even if a crack develops in the material it will not propagate further than the above-named component. Furthermore, because of the surprisingly good adhesion of the material to the above-named component, if the material cracks the separate pieces are more likely to remain in place rather than fall out. Preferably the majority of the fibres, tapes, fabric, meshes and/or gauze bandages are located within the material i.e. beneath the surface(s) of the material. Preferably the fibres, tapes, fabric, meshes and/or gauze bandages are located throughout a cross-section of the material. Preferably the mesh, fabric, tapes and/or fibres alternates with material comprising no mesh, fabric, tapes and/or fibres in a layered structure. Preferably the material comprises at least one, more preferably at least two layers of mesh, fabric, tapes and/or fibres. Preferably each layer of mesh, fabric, tapes and/or fibres is located in direct contact with two layers of material comprising no mesh, fabric, tapes and/or fibres. The higher the number of alternating layers of mesh, fabric, tapes and/or fibres and material containing no mesh, fabric, tapes and/or fibres, the higher the mechanical and/or form stability of the fire resistant composite material. The mesh can also act as a thermal barrier which provides good insulation. Preferably said tapes and/or fibres are arranged substantially parallel to one another.

In some embodiments at least some of the mesh, fabric, tapes and/or fibres have a longest dimension of preferably at least 0.2 mm, more preferably at least 0.5 cm, even more preferably at least 1 cm, but preferably at most 5 cm, more preferably at most 4 cm, even more preferably at most 3 cm. Such components can be added to the matrix for further reinforcement.

The gauze bandages may comprise basalt, glass, organic polymer, and/or cotton fibres. Said organic polymer may preferably comprise polypropylene. Gauze bandages of basalt, glass or organic polymers may have enough room between the fibres to allow the material to flow through the gaps during manufacture and in the event of a fire. Gauze bandages provide similar advantages to those that basalt mesh affords. Basalt fibres are preferred because they are stronger than cotton fibres and are not flammable.

Said fibres and/or tapes preferably comprise of inorganic and/or organic polymers, such as polyethylene, polypropylene, PET, polyester and/or nylon. Said tapes may comprise fabric tapes.

In the context of the mixture or the material, in certain embodiments preferably the cooling agent, not taking into account any associated water of crystallisation, is present at a total concentration of at least 5% by weight, more preferably at least 25% by weight, even more preferably at least 35% by weight, most preferably at least 45% by weight, but preferably at most 80% by weight, more preferably at most 70% by weight, even more preferably at most 60% by weight, most preferably at most 55% by weight based on the total weight of the mixture or the material. Such ranges are particularly suitable for applications in which the material is used in a frame that exhibits poor thermal isolation. These ranges allow for the presence of more isolating agent to prevent the loss of cooling liquids and vapours too quickly, as a result of the low thermal isolation of the frame.

In the context of the mixture or the material, in some other embodiments preferably the cooling agent, not taking into account any associated water of crystallisation, is present at a total concentration of at least 35% by weight, more preferably at least 55% by weight, even more preferably at least 75% by weight, most preferably at least 80% by weight, but preferably at most 95% by weight, more preferably at most 90% by weight, even more preferably at most 87% by weight, most preferably at most 85% by weight based on the total weight of the mixture or the material. Such ranges are particularly suitable for applications in which the material is used in a frame that exhibits good thermal isolation. In this case there is less need for the isolating agent and therefore more cooling agent can be used.

Preferably the cooling agent is granulated. Preferably the granulated cooling agent has an average volume-based particle size (where the size of a given particle equals the diameter of the sphere that has the same volume as the given particle) of less than 5 mm, more preferably less than 2 mm, even more preferably less than 1 mm, even more preferably less than 0.2 mm, most preferably less than 0.1 mm. These preferred ranges are beneficial because if the particles are too large this can cause inhomogeneities in the material which can affect stability and fire performance. Preferably the granulated cooling agent is a powder. The smaller the particle size of the cooling agent, the higher the form stability of the material, but the greater surface area that needs to be bound by the matrix. Particle size may be measured using a Malvern Mastersizer®. Preferably the granulated cooling agent comprises a mixture of particles with at least two, more preferably at least three, even more preferably at least four, different average volume-based particle sizes. Combining different particle sizes in one mixture helps to achieve a denser packing of the particles, which improves form stability, reduces porosity and uses available space more effectively.

In one embodiment the cooling agent preferably comprises at least two cooling agents. This arrangement is particularly suitable if the material is not subsequently coated with a powder.

Preferably the cooling agent comprises a first cooling agent comprising one or more of salt hydrates such as MgSO₄.7H₂O, NaSO₄.xH₂O (where x=0-10), NaHCO₃ and/or CaSO₄.xH₂O (where x=0-2), silica gel, molecular sieves, alkali-borates such as Na₂[B₄O₅(OH)₄].8H₂O, zinc-borates, organo-zinc-borates, glycols, polyols, non-flammable organic solvents such as DMSO and/or dried alkali metal silicates. The first cooling agent decomposes, releasing a cooling liquid, at relatively low temperatures of from around 90° C. to 180° C. which helps to lower the temperature in the initial stages of a fire. The first cooling agents are particularly suitable for applications that require a substantial amount of cooling in the event of a fire, such as in rooms containing very sensitive contents (e.g. gas bottles, computer devices). In certain embodiments, when present in the mixture or the material, preferably said first cooling agent, not taking into account any associated water of crystallisation, is present at a total concentration of at least 2% by weight, more preferably at least 10% by weight, even more preferably at least 15% by weight, most preferably at least 20% by weight, but preferably at most 40% by weight, more preferably at most 35% by weight, even more preferably at most 30% by weight, most preferably at most 25% by weight based on the total weight of the mixture or the material. Dried alkali metal silicates may contain up to 15% by weight of water, preferably up to 10% by weight, even more preferably up to 5% by weight.

Preferably the cooling agent further comprises a second cooling agent comprising one or more of Al(OH)₃, AlO(OH), Zn(OH)₂, Fe(OH)₂, Fe(OH)₃, FeO(OH), Ca(OH)₂, and/or Mg(OH)₂. The second cooling agent is stable at lower temperatures but decomposes, releasing a cooling liquid, at higher temperatures of from around 200° C. to 600° C. which helps to lower the temperature as a fire progresses and aids the retention of the shape of the material i.e. it helps prevent elasticity, sagging etc. The second cooling agent is particularly suited for material that is coated with a powder, for example in powder coated doors, bulkheads, blinds, or frames. For powder coated material, in view of the high temperature coating process, it is preferable if the material can maintain temperatures up to 180° C., preferably up to 220° C., for at least 30 minutes, preferably up to 90 minutes. In the case of powder coated material, preferably said material does not comprise dried alkali metal silicates. In some preferred embodiments the second cooling agent, preferably Al(OH)₃, has an average volume-based particle size (where the size of a given particle equals the diameter of the sphere that has the same volume as the given particle) of less than 300 μm, more preferably less than 100 μm, even more preferably less than 50 μm, most preferably less than 40 μm. These preferred particle sizes assist in enabling the Al(OH)₃ to close pores in the material. In some embodiments the material does not comprise a second cooling agent.

In certain embodiments, when present in the mixture or the material, preferably said second cooling agent, not taking into account any associated water of crystallisation, is present at a total concentration of at least 5% by weight, more preferably at least 20% by weight, even more preferably at least 30% by weight, most preferably at least 35% by weight, but preferably at most 75% by weight, more preferably at most 55% by weight, even more preferably at most 45% by weight, most preferably at most 40% by weight based on the total weight of the mixture or the material. Such ranges are particularly suitable for applications in which the material is used in a frame that exhibits poor thermal isolation. These ranges allow for the presence of more isolating agent to prevent the loss of cooling liquids and vapours too quickly, as a result of the low thermal isolation of the frame.

In some other embodiments, when present in the mixture or the material, preferably said second cooling agent, not taking into account any associated water of crystallisation, is present at a total concentration of at least 30% by weight, more preferably at least 45% by weight, even more preferably at least 60% by weight, most preferably at least 65% by weight, but preferably at most 90% by weight, more preferably at most 85% by weight, even more preferably at most 80% by weight, most preferably at most 75% by weight based on the total weight of the mixture or the material. Such ranges are particularly suitable for applications in which the material is used in a frame that exhibits good thermal isolation. In this case there is less need for the isolating agent and therefore more cooling agent can be used.

Preferably the cooling agent comprising one or more of MOH, M₂O, M₂SO₄, MHSO₄, M(PO₃)₃, MₓH₃₋ₓPO₄ (where x=0 to 3), M₂CO₃, MHCO₃, borates such as M₂[B₄O₅(OH)₄] (where M=Li, Na, K, and/or NH₄), M′(OH)₂, M′O, M′CO₃, M′SO₄, M′PO₄ (where M′=Ca, Mg, Ba, Sr, and/or Fe), Al(OH)₃, Fe(OH)₃, Si(OH)₄, SiO(OH)₂, FeO(OH), AlO(OH), and/or salts thereof is hydrated i.e. said cooling agent possesses some water of crystallisation. For example said cooling agent may comprise M₂[B₄O₅(OH)₄].8H₂O (where M=Li, Na, K, and/or NH₄).

The silica gel may preferably have been produced by reacting an alkali metal silicate with an acid, such as H₂SO₄ and/or H₃PO₄. Commercially available silica gel has normally been dried so that it is able to reduce local humidity. However, such silica gel will be structurally destroyed if it is added directly to a liquid (e.g. water) and will consequently not be able to retain water. In order to incorporate water into commercially available silica gel it can be loaded by placing in a water-vapour rich atmosphere. This onerous step can be avoided by reacting an alkali metal silicate with an acid which enables a high water content silica gel to be formed in a water-based liquid. The silica gel can be dried to remove any excess water to avoid subsequent shrinkage of the material of the present invention. If the material comprises silica gel, said silica gel may be able to reduce the local humidity by increasing its own water content and therefore its cooling behaviour.

Preferably the silica gel comprises at least 5% by weight water, more preferably at least 10% by weight, even more preferably at least 15% by weight, most preferably at least 20% by weight, but preferably at most 45% by weight water, more preferably at most 30% by weight, most preferably at most 25% by weight based on the total weight of the mixture. These preferred ranges ensure sufficient cooling effect without undesirable shrinkage of the material.

The cooling agent may further comprise one or more hygroscopic compounds. These compounds are able to increase the content of water in the material by reducing the local humidity. In some embodiments, alternatively or additionally, the matrix may comprise layer silicates e.g. wollastonites and/or zeolites, and/or comprise grog (chamotte), mullite and/or bentonite which can be used to store water.

The cooling agent may comprise one or more glycol and/or polyol. Preferably the glycol is ethylene glycol. Preferably the polyol is glycerol and/or polyethyleneglycol. When present in the mixture or the material, preferably the polyol is present at a total concentration of at least 1% by weight, more preferably at least 2% by weight, even more preferably at least 4% by weight, most preferably at least 4% by weight, but preferably at most 20% by weight, more preferably at most 15% by weight, even more preferably at most 10% by weight, most preferably at most 8% by weight based on the total weight of the mixture or the material. As the concentration of polyol increases, the flexibility of the material which is produced when the mixture is dried or cured increases. However the incorporation of an excessive proportion of polyol can be disadvantageous due to an increase in flammability.

The one or more alkali metal silicates may be granulated. Preferably the granulated alkali metal silicates have an average volume-based particle size (where the size of a given particle equals the diameter of the sphere that has the same volume as the given particle) of more than 0.001 mm, more preferably more than 0.01 mm, even more preferably more than 0.1 mm, but preferably less than 5 mm, more preferably less than 2 mm, even more preferably less than 1 mm, even more preferably less than 0.5 mm, most preferably less than 0.25 mm. These preferred ranges are beneficial because if the particles are too small they may dissolve in the mixture, but if they are too large this can cause inhomogeneities in the material which can affect stability and fire performance. Preferably the granulated alkali metal silicates are a powder. The granulated alkali metal silicates may have undergone a drying process prior to incorporation in the mixture and/or material.

The molar ratio of SiO₂:M₂O of the alkali metal silicates in the mixtures and materials of the present invention, where M represents an alkali metal cation, is preferably at least 1.6:1 and more preferably is in the range 2.0:1 to 6.0:1, even more preferably in the range 2.0:1 to 5.0:1, most preferably in the range 2.0:1 to 4.0:1. Silicate solutions having a molar ratio of SiO₂:M₂O in the range 2:1 to 4:1 are available as articles of commerce. Specifically solutions wherein this ratio is 2.0:1, 2.5:1, 2.85:1, 3.0:1 and 3.3:1 are available as articles of commerce. Solutions having a molar ratio of SiO₂:M₂O between these values may be produced by blending these commercially available materials. In some preferred embodiments sodium silicate solution is prepared by mixing aqueous NaOH solution with aqueous silica sol. It can be beneficial to premix such a silicate solution with components such as Ca(OH)₂ to afford better control by preventing an instantaneous reaction with the silicate.

Preferably the isolating agent comprises one or more of hollow microspheres and/or foam microspheres. Preferably said hollow microspheres comprise hollow glass microspheres and/or hollow ceramic microspheres. Preferably said foam microspheres comprise foam glass granulates and/or foam ceramic granulates. In some cases the isolating agent may alternatively or additionally comprise polymer microspheres. Polymer microspheres are advantageous because their properties can be varied to a great extent. Therefore adhesion with the matrix can be optimized, which increases the form stability. In some embodiments the microspheres are coated with functional groups. These groups may react with the matrix. Such reactions can further stabilise the matrix. Preferably the hollow microspheres have an average volume-based particle size (where the size of a given particle equals the diameter of the sphere that has the same volume as the given particle) of more than 40 μm, more preferably more than 80 μm, even more preferably more than 100 m, but preferably less than 2 mm, more preferably less than 500 μm. In some embodiments the isolating agent may alternatively or additionally comprise metals, glass- and/or ceramic-flakes. Hollow glass microspheres and/or glass flakes melt at around 900° C. to form a glass film which isolates the cooling agent and acts as a barrier to the release of cooling liquids and vapours to ensure that they are released gradually. Preferably the glass flakes comprise borosilicate glass. Ceramic flakes do not melt at temperatures of around 900° C. and therefore only act as a barrier in the event of a fire. Although metals, e.g. metal foil and/or metal foil flakes, have a good heat transfer rate, they can also be used as an isolating agent because, due to their barrier function with regard to water and/or water vapour, they help to reduce the loss of water during a fire. The metal may be for example aluminium, zinc and/or any metal, which is oxidized under these conditions. The metal may be in form of particles, such as nanoparticles. The metal may be introduced as a suspension in a carrier liquid. The metals may also react under basic conditions and form a stable intrinsic foam. For example aluminium particles (or zinc particles), e.g. nanoparticles, and/or small pieces (i.e. an average volume-based particle size of less than 1 mm) of the metal, when added to the mixture can result in the formation of aluminates and the release of hydrogen gas which forms a stable foam. Some embodiments may comprise one or more alkali-hydroxides, which can activate the metal. Aluminates such as Na[Al(OH)₄] are able to react in the presence of heat, which provides further cooling properties.

In some embodiments the cooling agent is encapsulated in one or more foil package, preferably one or more metal foil package. This is beneficial for cooling agents whose cooling properties are potentially influenced by the matrix. The foil may melt under heat and release the cooling agent. In this embodiment preferably the cooling agent comprises one or more of an aqueous gel and/or solution such as a salt solution, an at least partly organic liquid, and/or alkali metal silicates. Different cooling agents may be encapsulated in separate foil packages. In some embodiments, two or more foil packages may contain cooling agents that can react with each other upon contact e.g. if the foil of said packages melts in the event of a fire. The packages can be limited in size such that sawing, drilling and other processes are possible without detrimental effects on fire resistance. Preferably the packages contain a volume of cooling agent of up to 100 cm³, more preferably 25 cm³, even more preferably 100 cm³, most preferably below 5 cm³.

In another embodiment the fire resistant composite material may be encapsulated by a foil package. This arrangement reduces the loss of unbound water.

When present in the mixture or the material, preferably said isolating agent is present at a total concentration of at least 0.1% by weight, more preferably at least 1% by weight, even more preferably at least 2% by weight, most preferably at least 3% by weight, but preferably at most 50% by weight, more preferably at most 25% by weight, even more preferably at most 10% by weight, most preferably at most 5% by weight based on the total weight of the mixture or the material. These preferred ranges help ensure the appropriate level of isolation of cooling liquids and vapours and reduce the density of the material.

When present in the mixture or the material, preferably said hollow microspheres are present at a total concentration of at least 0.5% by weight, more preferably at least 1% by weight, even more preferably at least 2% by weight, most preferably at least 3% by weight, but preferably at most 75% by weight, more preferably at most 25% by weight, even more preferably at most 10% by weight, most preferably at most 5% by weight based on the total weight of the mixture or the material. These preferred ranges help ensure the appropriate level of isolation of cooling liquids and vapours and reduce the density of the material. A higher amount of hollow microspheres provides excellent thermal insulation at low density, which can be beneficial in the space and/or aircraft industry.

When present in the mixture or the material, preferably the wood and/or cellulose chips incorporate an alkali metal silicate.

Alternatively or additionally the isolating agent may comprise one or more expandable polymer such as polystyrene, preferably Styropor®. These isolating agents are beneficial because they can reduce the U-value of a system, indicating improved thermal insulation.

Alternatively or additionally the isolating agent may comprise one or more mineral such as talc, kaolin, pyrophyllite, bentonite, chlorite, vermiculite and/or mica. Such minerals are advantageous because they help to retain any unbound water in the material by effectively closing pores. Said one or more mineral may be combined with one or more alkali metal silicate. The combination of said mineral and said alkali metal silicate may be in the form of a liquid, for example by further comprising water. Said combination may be provided as a coating on the material.

The material and/or mixture may further comprise one or more retarder, such as D(−) tartaric acid, L(+) tartaric acid, alkali phosphates, borates such as borax or boric acid, and/or gluconic acid and/or its salts, preferably sodium gluconate, glucoheptonate and/or sodium glucoheptonate anhydrate. Polyols such as glycerol, and salts such as CaO, MgO, and/or (NH₄)₃PO₄ are also useful to influence the hardening time. Retarders slow the curing process which makes the mixture easier to handle and therefore the manufacture of the material is simplified. The retarder may preferably be present at a total concentration of at least 0.1% by weight, more preferably at least 0.5% by weight, even more preferably at least 1% by weight, most preferably at least 3% by weight, but preferably at most 20% by weight, more preferably at most 10% by weight, even more preferably at most 7% by weight, most preferably at most 5% by weight based on the total weight of the mixture or the material.

In one embodiment the material is preferably encapsulated in a tubing, preferably in heat-shrink tubing. In another embodiment the material is encapsulated in a solid sheathing. The tubing and/or sheathing may comprise one or more polymer and/or polymer-containing substance such as acrylic acid/methacrylic acid copolymers, acrylates, e.g. styrene acrylates or other derivates, latex, vinyl-acetates, e.g. polyvinyl-acetate or derivates, polyvinyl polymers, polyolefins such as polyethylene and/or polypropylene, PET, polyethanolate, polyurethane, polyesters, celluloses such as methyl cellulose and/or hydroxymethyl-cellulose, epoxy resins, phenolic resins, polycarboxylate ethers, nylon, fluoropolymer (such as FEP, PTFE or Kynar), PVC, neoprene, silicone elastomer, fibreglass, waxes and/or Viton. The material may be encapsulated by spraying, coating and/or painting with said polymer and/or polymer-containing substance and/or dipping in said polymer and/or polymer-containing substance. Such tubing enhances the mechanical stability and fire performance of the material because the tubing is able to capture any unbound water, preventing it evaporating over time. Of course it is also possible to encapsulate the material in metal foil, preferably aluminium metal foil, to avoid the loss of solvent, preferably water and/or water vapour.

The material may be opaque in appearance. An opaque material can be advantageous in situations where privacy is paramount such as in wall partitions, doors and flooring. Additionally the aesthetic appeal of the material makes it attractive for these applications.

The material of the present invention may be in the form of a layer, rod, tube, plate or block. Said rod or tube may be polyangular. Said layer, rod, plate, block, plate or tube may have at least one recess and/or protrusion. At least a portion of the material may be straight, branched and/or curved. The material may further comprise one or more openings or slots. Such an arrangement enables the material to be locked to a separate element such as a frame or another section of material. The thickness of a layer of the material may vary through a wide range such as from 1 to 300 mm, preferably from 5 to 100 mm, more preferably from 10 to 25 mm. The length of a rod or block of the material may vary from 1 to 400 cm, preferably from 5 to 300 cm, more preferably from 10 to 150 cm. The depth and/or width of a rod or block of the material may vary from 1 to 200 cm, preferably from 5 to 100 cm, more preferably from 10 to 70 cm.

The material may be in combination with metals, such as iron, steel and/or alumina, ceramics, glass, organic polymers, plastics, organic polymers with fibers and/or fibreglass. For example, the material may encapsulate wires and/or rods. The material may comprise one or more cavity. Said cavities may enable the insertion of wires and/or rods. Said wires and/or rods may provide reinforcement and/or enable the material and/or other elements to be locked in place. Preferably the material is a combination of components with a compressive strength of at least 10 N/mm², more preferably of at least 100 N/mm², most preferably of at least 200 N/mm², and components with a bending strength of at least 10 N/mm², more preferably of at least 100 N/mm², most preferably of at least 200 N/mm². In some embodiments the compressive stress increases with temperature over time. This is beneficial because in a fire typically materials begin to soften over time due to the elevated temperatures. Consequently, the combination of fibreglass (excellent properties at room and slightly increased temperatures) and the material of the present invention (excellent properties under heat) is beneficial.

According to a third aspect of the present invention there is provided an insert for a fire resistant article such as a glazing frame, wall, bulkhead, blind, and/or door, or a part thereof, wherein the insert incorporates the material of the first aspect of the present invention.

The insert may comprise more than one material according to the first aspect. In some embodiments the insert may comprise at least two layers. Preferably each of said at least two layers comprises one material according to the first aspect. Preferably where any layers are in direct contact with each other, said layers that are in direct contact comprise different materials. The insert may comprise at least three layers. Each of said at least three layers may comprise one of at least two materials according to the first aspect. In one embodiment the layers may alternate between two different materials. The insert may comprise at least four or five layers. In one embodiment the layers may comprise one or more core layer of a first material located between two layers of a second material. Said two layers of a second material may be located between two layers of a third material. In another embodiment the insert may comprise one or more materials according to the first aspect encapsulated by a different material according to the first aspect.

The insert may be encapsulated in a material such as metal, plastic and/or fibreglass.

According to a fourth aspect of the present invention there is provided a fire resistant article such as a glazing frame, wall, bulkhead, window blind, cable channel and/or a door, or a part thereof, that incorporates the insert of the third aspect of the present invention.

In complex articles such as frames, walls, bulkheads, window blinds, cable channels and/or doors, or a part thereof, it can be advantageous to use different types of materials simultaneously. Complex articles may provide more than one space for inserts. Depending on the location, the amount of cooling and isolating agent can be optimized.

For example, a frame, door, bulkhead, window blind, cable channel and/or wall, or a part thereof, may comprise at least one cavity, such as at least two or at least three cavities. Said at least three cavities may comprise at least one, preferably one, inner cavity and at least two, preferably two, outer cavities. For example, the frame, door, bulkhead, window blind, cable channel and/or wall, or a part thereof, may comprise three cavities arranged such that two outer cavities sandwich an inner cavity between them. Said frame, door, bulkhead, window blind, cable channel and/or wall, or a part thereof, may each comprise at least one major surface that contacts an external environment, for instance where a fire may occur. Each outer cavity may be adjacent to one of said major surfaces. Each outer and/or inner cavity may be at least partially, preferably completely, surrounded by a housing, typically a metal, fibreglass or plastic housing. In the case where an outer cavity is substantially completely or completely surrounded by a housing, the outer cavity has little or no contact with the external environment. Such outer cavities may be linked together via at least one bridge, forming an inner cavity between said outer cavities. Said bridge may comprise a grid, mesh, tube, rod and/or plate etc., typically manufactured from metal and/or fibreglass. Said inner cavity often may be in contact with an environment that is partitioned from an external environment where a fire may occur, e.g. said inner cavity may be partitioned from an external environment by the presence of a glazing edge and/or seal. A housing of an inner cavity may comprise one or more gaps along a side that may contact an external environment, being distinct from a side that contacts another cavity. Furthermore, in some embodiments the housing of an inner cavity of said side that may contact an external environment may be completely absent or absent over up to 95%, up to 90%, or up to 80% of the surface area of said inner cavity along said side. An outer cavity may be linked to an inner cavity by one or more gaps and/or bars, preferably metal bars. Said one or more gaps may comprise gaps in a housing of said outer cavity. In some embodiments at least part of the bridge may comprise the material of the first aspect. This arrangement can further reduce the heat transfer between cavities, enhancing fire performance. For example the bridge may comprise at least one grid and/or hollow body that is at least partly filled with the material of the first aspect. Preferably the hollow body is a hollow tube or a hollow polygonal rod. Said hollow body may be a T- or L-shaped hollow tube or rod. Each of the cavities may be any suitable shape such as a polyhedron, e.g. rectangular cuboid shaped. One or more of the cavities may have rounded edges.

It is preferred that the frame, door, bulkhead, window blind, cable channel and/or wall, or a part thereof, comprises at least three cavities arranged such that two outer cavities sandwich one or more inner cavities between them. Preferably at least one of said inner cavities is at least partially, or alternatively completely, separated from an external environment and/or at least one of said outer cavities by a housing. Said housing may be manufactured from one or more metal, plastic and/or fibreglass. Preferably at least one of said inner cavities contains a first material according to the present invention and i) a void and/or ii) a second material according to the present invention.

Preferably at least one of said inner cavities is at least partially, or alternatively completely, separated from at least one of said outer cavities by a housing. In some embodiments it is preferred that the housing comprises a plurality of sections, wherein at least one section of the housing comprises the first fire resistant material, wherein said first fire resistant material separates the inner cavity from an external environment at said section. Preferably said inner cavity is separated from an external environment at said section solely by the first fire resistant material. Said first fire resistant material can act as a housing in this case, such that any further housing may be absent or only partially present at said section of the housing.

Said void may contain a gas, preferably air, or a vacuum. The gas acts as an insulator, preventing heat transfer between the outer cavities. If the void contains a different gas or a vacuum instead of air then sufficient encapsulation is needed. The void may be sealed in the housing and/or any suitable encapsulation.

Said second material according to the present invention preferably comprises one or more of hollow microspheres and/or foam microspheres. These microspheres can encapsulate gases, such as air, water vapour, CO₂, SOₓ, NOₓ and/or N₂, or a vacuum which improves the insulating properties of the second material. Preferably said hollow microspheres comprise hollow glass microspheres and/or hollow ceramic microspheres. Preferably said foam microspheres comprise foam glass granulates and/or foam ceramic granulates. Alternatively or additionally the hollow microspheres may comprise polymer microspheres. Hollow glass microspheres and hollow ceramic microspheres provide improved insulation and mechanical stability characteristics. Foam microspheres generally comprise a more open pore structure such that they are better able to adsorb substances, e.g. water vapour, which means that foam microspheres can enhance the fire performance by adsorbing water vapour released by any adjacent material of the present invention in the event of a fire, cooling said adsorbed water and storing it until such time that the temperature is high enough to cause the water to vaporise again.

Preferably said article incorporate at least two different inserts. Preferably an outer insert incorporated in an outer cavity comprises at least 40% by weight, more preferably at least 60% by weight, even more preferably at least 70% by weight of cooling agent. Preferably an outer insert incorporated in an outer cavity comprises at most 20% by weight, more preferably at most 10% by weight, even more preferably at most 5% by weight of isolating agent. Because the heat transfer through a metal housing can be very high, in the event of a fire the heat from the fireside can quickly reach the outer insert. Therefore the outer insert at the fireside will be consumed from outside to inside. Any isolating agent that is present in the outer insert can help to ensure that the cooling agent is not consumed too quickly.

Preferably an inner insert incorporated in an inner cavity comprises at least 20% by weight, more preferably at least 40% by weight, even more preferably at least 70% by weight of isolating agent. Preferably an inner insert incorporated in an inner cavity comprises at most 20% by weight, more preferably at most 10% by weight, even more preferably at most 5% by weight of cooling agent. The inner insert can act like a shield for the outer insert at the non-fire side because the heat from the fire is only able to transfer via the at least one bridge, and the inner insert is not surrounded by the heat, but instead experiences heat mainly from one side. In this case the insulating behaviour provided by the isolating agent is particularly beneficial.

According to a fifth aspect of the present invention there is provided a fire resistant glazing assembly comprising at least one fire resistant glazing attached to a fire resistant glazing frame of the fourth aspect of the present invention.

According to a sixth aspect of the present invention there is provided a building incorporating the material of the first aspect of the present invention, the fire resistant article of the fourth aspect, and/or the fire resistant glazing assembly of the fifth aspect.

According to a seventh aspect of the present invention there is provided a method of preparing a material according to the first aspect of the present invention comprising: drying and/or curing a mixture in accordance with the second aspect of the present invention.

According to an eighth aspect of the present invention there is provided a method of preparing a mixture according to the second aspect of the present invention comprising combining:

a) one or more liquid, one or more of silicates of the elements of Groups 1, 2, 13 and/or 14 of the periodic table, phosphates of the elements of Group 13 of the periodic table and/or organo compounds of the elements of Group 13 of the periodic table, Ca(Hal)₂, Mg(Hal)₂ (where Hal=OH, F, Cl, Br, or I); and

b) one or more of MOH, M₂O, M₂SO₄, MHSO₄, M(P0₃)₃, MₓH₃₋ₓPO₄ (where x=0 to 3), M₂CO₃, MHCO₃, borates such as M₂[B₄O₅(OH)₄], (where M=Li, Na, K, and/or NH₄), M′(OH)₂, M′O, M′CO₃, M′SO₄, M′PO₄ (where M′=Ca, Mg, Ba, Sr, and/or Fe), Al(OH)₃, Fe(OH)₃, Si(OH)₄, SiO(OH)₂, FeO(OH), AlO(OH), salts thereof, silica gel, molecular sieves, glycols, polyols, non-flammable organic solvents, dried alkali metal silicates and/or saccharides; and/or

c) one or more of hollow microspheres, foam microspheres, glass flakes, ceramic flakes, wood chips and/or cellulose chips.

A layer of the material may conveniently be produced by spreading the mixture onto the surface of a substrate and drying and/or curing the mixture. In order to produce a layer of material of the desired thickness it is sometimes necessary to provide an edge barrier on the substrate which will retain the mixture during evaporation. Some other forms of the material, such as rods, blocks, tubes, polyangular and curved forms, and forms with cavities, recesses and/or openings may be produced by pouring the mixture into a mould or a structure such as a glazing frame, followed by drying and/or curing of the mixture. The drying and/or curing process may preferably be carried out at an elevated temperature for example of at least 30° C., preferably at least 60° C., but preferably at most 110° C., more preferably at most 100° C., most preferably at most 90° C. The drying and/or curing process may be carried out for a period of preferably at least 2 hours, more preferably at least 6 hours. At room temperature the drying and/or curing takes longer, dependent on the thickness of the form and the surrounding humidity.

According to a ninth aspect of the present invention there is provided the use of a material according to the first aspect of the present invention to prevent the spread of fire.

Preferably said use is in partitions, walls, floors, ceilings, as inserts in doors and glazing frames, in the body of vehicles, as encapsulation for wires or rods. Said use may additionally be as a structural element or otherwise to replace or augment the use of metal profiles, such as iron, steel and/or alumina profiles, ceramics, plastic, wood, organic polymers, organic polymers with fibers and/or fibreglass. Said use may additionally or alternatively be as a paint, sealant e.g. as a cable and/or pipe sealant, coating, glue, fugue and/or mortar, e.g. in fire protection ducts and joints, and/or fire dampers.

According to a tenth aspect of the present invention there is provided a fire resistant article such as a frame, bulkhead, door, window blind, cable channel and/or wall, or a part thereof, comprising at least one cavity,

wherein said at least one cavity is at least partially separated from an external environment by a housing,

wherein said at least one cavity contains a first fire resistant material and

i) a void and/or

ii) a second fire resistant material.

Preferably said at least one cavity is completely separated from an external environment by a housing. Said housing may comprise a metal, fibreglass and/or plastic housing. In some embodiments it is preferred that the housing comprises a plurality of sections, wherein at least one section of the housing comprises the first fire resistant material, wherein said first fire resistant material separates the inner cavity from an external environment at said section. Preferably said inner cavity is separated from an external environment at said section solely by the first fire resistant material. Said first fire resistant material can act as a housing in this case, such that any further housing may be absent or only partially present at said section of the housing.

The article may comprise at least two or at least three cavities. Said at least three cavities may comprise at least one, preferably one, inner cavity and at least two, preferably two, outer cavities. For example, the article may comprise three cavities arranged such that two outer cavities sandwich an inner cavity between them. Said article may comprise at least one major surface that contacts an external environment, for instance where a fire may occur. Each outer cavity may be adjacent to one of said major surfaces. Each outer and/or inner cavity may be at least partially, preferably completely, surrounded by a housing, typically a metal, fibreglass or plastic housing. In the case where an outer cavity is substantially completely or completely surrounded by a housing, the outer cavity has little or no contact with the external environment. Such outer cavities may be linked together via at least one bridge, forming an inner cavity between said outer cavities. Said bridge may comprise a grid, tube, rod and/or plate etc., typically manufactured from metal and/or fiberglass. Said inner cavity may be in contact with an environment that is partitioned from an external environment where a fire may occur, e.g. said inner cavity may be partitioned from an external environment by the presence of a glazing edge. A housing of an inner cavity may comprise one or more gaps along a side that may contact an external environment, being distinct from a side that contacts another cavity. Furthermore, in some embodiments the housing of an inner cavity of said side that may contact an external environment may be completely absent or absent over up to 95%, up to 90%, or up to 80% of the surface area of said inner cavity along said side. An outer cavity may be linked to an inner cavity by one or more gaps and/or bars, preferably metal bars. Said one or more gaps may comprise gaps in a housing of said outer cavity. In some embodiments at least part of the bridge may comprise the material of the first aspect. This arrangement can further reduce the heat transfer between cavities, enhancing fire performance. For example the bridge may comprise at least one grid and/or hollow body that is at least partly filled with the material of the first aspect. Preferably the hollow body is a hollow tube or a hollow polygonal rod. Said hollow body may be a T- or L-shaped hollow tube or rod. Each of the cavities may be any suitable shape such as a polyhedron, e.g. rectangular cuboid shaped. One or more of the cavities may have rounded edges.

When the article comprises only one cavity, it is preferred that the cavity does not comprise a void. In this embodiment preferably the first and second fire resistant materials are the same. Preferably the first and second fire resistant materials are according to the present invention.

It is preferred that the article comprises at least three cavities arranged such that two outer cavities sandwich one or more inner cavities between them. Preferably at least one of said inner cavities is at least partially, or alternatively completely, separated from an external environment and/or at least one of said outer cavities by a housing. Said housing may be manufactured from one or more metal, plastic and/or fibreglass. Preferably at least one of said inner cavities contains a first fire resistant material and i) a void and/or ii) a second fire resistant material.

Preferably at least one of said inner cavities is at least partially, or alternatively completely, separated from at least one of said outer cavities by a housing. In this case, preferably said at least one inner cavity is separated from an external environment by a first fire resistant material. Said first fire resistant material may act as a housing in this case, such that any further housing may be absent or only partially present where said inner cavity contacts an external environment.

Said void may contain a gas, preferably air, or a vacuum. The gas acts as an insulator, preventing heat transfer between the outer cavities. If the void contains a different gas or a vacuum instead of air then sufficient encapsulation is needed. The void may be sealed in the housing and/or any suitable encapsulation.

Said second fire resistant material preferably comprises one or more of hollow microspheres and/or foam microspheres. These microspheres can encapsulate gases, such as water vapour, CO₂, SOₓ, NOₓ and/or N₂, or a vacuum which improves the insulating properties of the second material. Preferably said hollow microspheres comprise hollow glass microspheres and/or hollow ceramic microspheres. Preferably said foam microspheres comprise foam glass granulates and/or foam ceramic granulates. Alternatively or additionally the hollow microspheres may comprise polymer microspheres. Hollow glass microspheres and hollow ceramic microspheres provide improved insulation and mechanical stability characteristics. Foam microspheres generally comprise a more open pore structure such that they are better able to adsorb substances, e.g. water vapour, which means that foam microspheres can enhance the fire performance by adsorbing water vapour released by any adjacent material of the present invention in the event of a fire, cooling said adsorbed water and storing it until such time that the temperature is high enough to cause the water to vaporise again.

Said first and/or second fire resistant material may be a material that is based on an alkali metal silicate, gypsum, aluminium hydroxide and/or minerals such as wollastonite and/or bentonite. Preferably the first and second fire resistant materials are different. Said first and/or second fire resistant material may be a material according to the present invention. Preferably the material is a combination of components with a compressive strength of at least 10 N/mm², more preferably of at least 100 N/mm², most preferably of at least 200 N/mm², and components with a bending strength of at least 10 N/mm², more preferably of at least 100 N/mm², most preferably of at least 200 N/mm².

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention will now be further described by way of the following specific embodiments, which are given by way of illustration and not of limitation, with reference to the accompanying drawings in which:

FIG. 1 is a schematic view, in cross section, of a part of a fire resistant glazing frame incorporating a material according to the present invention in two outer cavities;

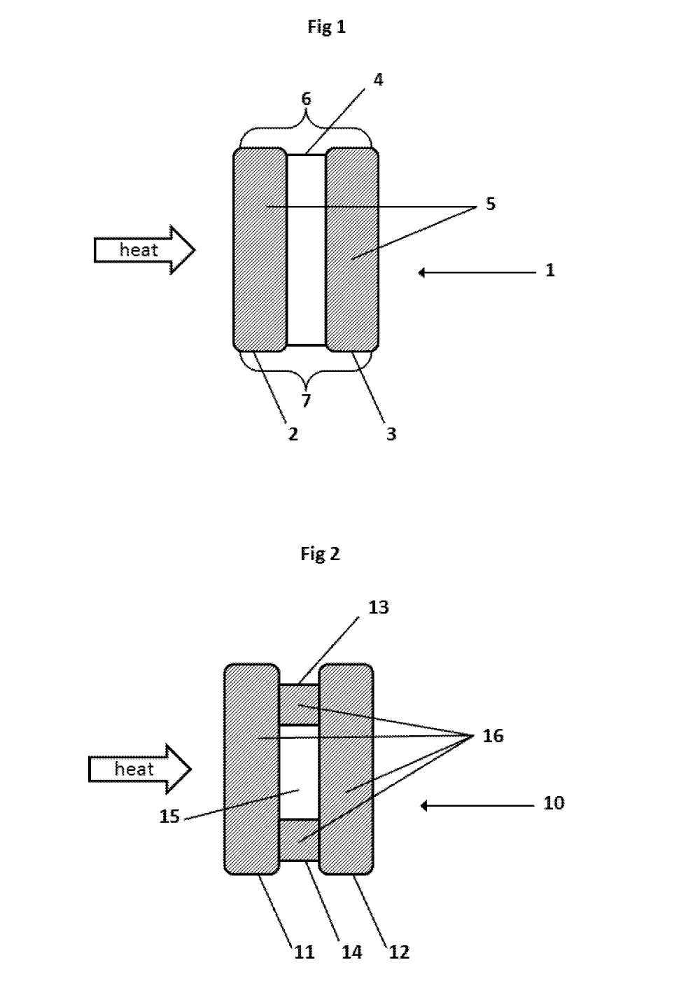

FIG. 2 is a schematic view, in cross section, of a part of a fire resistant glazing frame incorporating a material according to the present invention in two outer cavities and in two inner cavities;

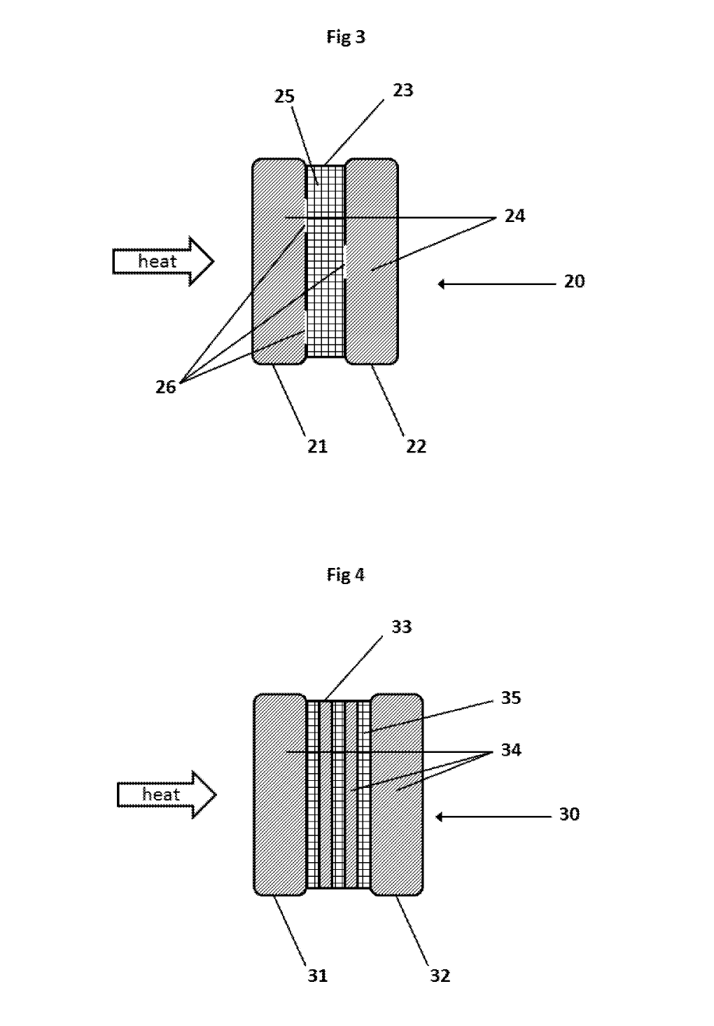

FIG. 3 is a schematic view, in cross section, of a part of a fire resistant glazing frame incorporating a material according to the present invention in two outer cavities and a further material of the present invention in an inner cavity, there being a number of passages between the outer cavities and the inner cavity;

FIG. 4 is a schematic view, in cross section, of a part of a fire resistant glazing frame incorporating a material according to the present invention in two outer cavities and in an inner cavity alongside a further material of the present invention as part of an alternating arrangement of layers;

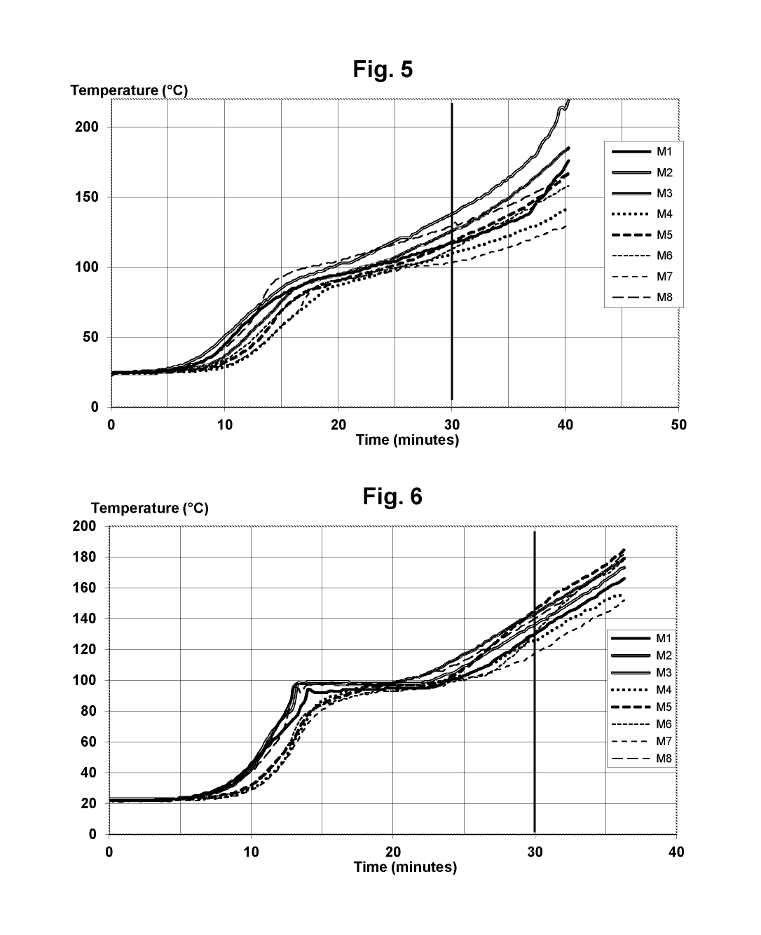

FIG. 5 shows the plots of the temperature detected by each of eight frame sensors as a function of time when using the inserts of Example 1;

FIG. 6 shows the plots of the temperature detected by each of the eight frame sensors as a function of time when using the inserts of Example 2;

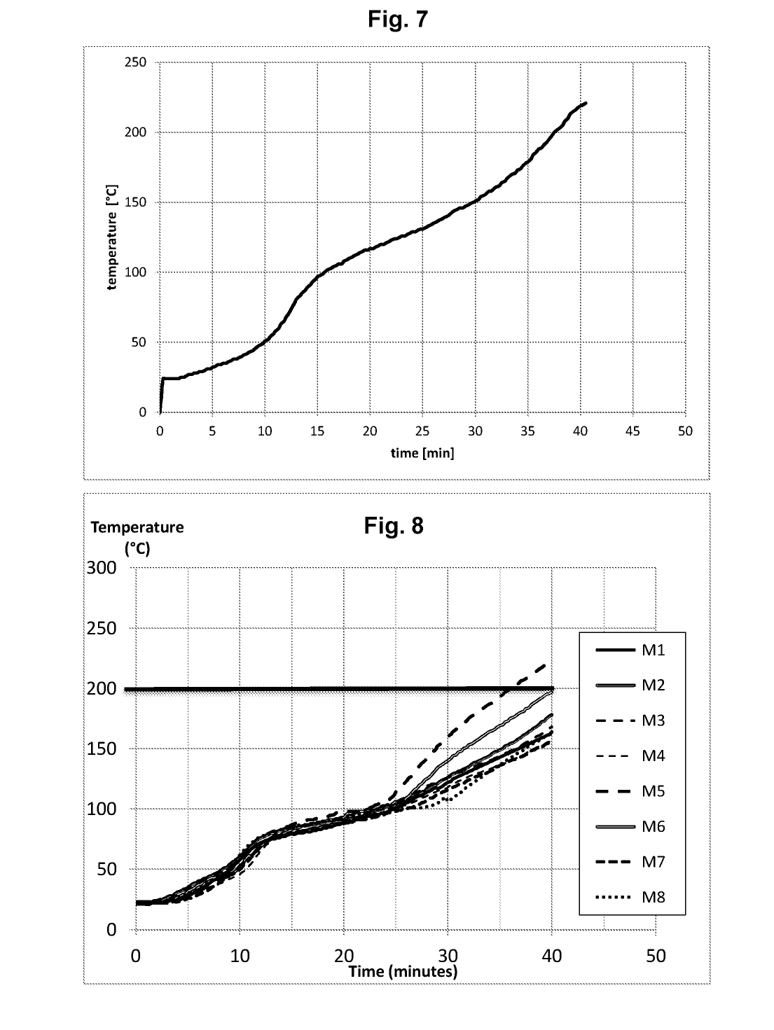

FIG. 7 shows the plot of the average temperature detected by the eight frame sensors as a function of time when using the inserts of Example 3; and

FIG. 8 shows the plots of the temperature detected by each of the eight frame sensors as a function of time when using the inserts of Example 5.

FIG. 1 illustrates a cross sectional view of part of a fire resistant glazing frame 1, namely an elongate part used to frame one edge of a fire resistant glazing. The cross sectional view is taken along any notional plane that lies parallel to the shortest dimension of part 1 (and perpendicular to the longest edges of part 1). Part 1 comprises two outer cavities 2, 3 and an inner cavity 4. Cavities 2, 3, 4 are encased in metal housings, although polymeric housings can be used. Said cavities 2, 3, 4 are rectangular cuboid shaped although outer cavities 2, 3 can have rounded edges, as shown in this embodiment. Outer cavities 2, 3 sandwich inner cavity 4 between them such that the two outer surfaces with the largest surface area of the housing of inner cavity 4 each contact a different outer cavity 2, 3 at one of the two outer surfaces with the larger surface area of the housing of each outer cavity 2, 3. Outer cavities 2, 3 have the same dimensions in most cases, whereas inner cavity 4 has normally smaller dimensions, as shown in this particular embodiment. In some alternative embodiments the outer cavities 2, 3 can be divided into smaller subcavities of varying shapes. Exposed elongate surfaces of inner cavity 4 located at elongate sides 6, 7 of part 1 are recessed in comparison with adjacent surfaces of outer cavities 2, 3 in the embodiment shown. Furthermore, in this embodiment inner cavity 4 is thinner than outer cavities 2, 3 in the dimension viewed across elongate sides 6, 7, although this may not be the case in some arrangements. Both outer cavities 2, 3 are filled with a material 5 of the present invention. Inner cavity 4 does not contain said material 5, i.e. it contains air. Alternatively or additionally the inner cavity 4 may contain one or more rods, tubes, plates, and/or mesh which may form one or more braces or bridges between the outer cavities 2, 3. In an alternative embodiment the housing of inner cavity 4 may comprise one or more gaps along either or both of elongate sides 6, 7. Furthermore, in some embodiments the housing of inner cavity 4 at either or both of elongate sides 6, 7 may be completely absent or absent over up to 95%, up to 90%, or up to 80% of the surface area of said inner cavity 4 along either of elongate sides 6, 7. In use, an edge of a fire resistant glazing is positioned adjacent and parallel to an elongate side 6, 7 of part 1. One or both of outer cavities 2, 3 may further comprise a flange at elongate side 6 or 7 protruding perpendicular to said side 6, 7 which helps retain such a glazing in place. The arrow labelled “heat” indicates a side of the part 1 that may first be exposed to a fire (alternatively, the opposing side of part 1, i.e. adjacent outer cavity 3, may first be exposed to a fire). Air is a good insulator and therefore in this embodiment the heat of a fire is not easily transferred from one outer cavity to the other outer cavity. This helps the frame insulate and retain its integrity.

FIG. 2 illustrates a cross sectional view of another embodiment of an elongate part of a fire resistant glazing frame 10. Part 10 is the same as the part 1 shown in FIG. 1 except that in the embodiment of FIG. 2 part 10 comprises three inner cavities 13, 14, 15 rather than one. Said inner cavities are arranged such that the housing of central inner cavity 15 is encircled by and in contact with the housing of each of outer cavities 11, 12 and inner cavities 13, 14. All of the cavities are filled with a material 16 of the present invention apart from central inner cavity 15 which is empty (i.e. contains air) or is filled with an insulator of a composition that may be different to material 16. Any of the cavities 11-15 could also contain reinforcements to improve the stability of the frame. In an alternative embodiment the inner cavities 13, 14 may be partially or completely absent a housing. In comparison with the embodiment of FIG. 1, the embodiment of FIG. 2 comprises additional filled cavities 13, 14 which provide enhanced cooling characteristics in the event of a fire.

FIG. 3 illustrates a cross sectional view of another embodiment of an elongate part of a fire resistant glazing frame 20. Part 20 is the same as part 1 shown in FIG. 1 except that in the embodiment of FIG. 3 the inner cavity 23 of part 20 is filled with a material of the present invention 25 that is different to the material of the present invention 24 that fills outer cavities 21, 22. Another difference is that part 20 comprises a number of gaps 26 in the housing between the outer cavities 21, 22 and the inner cavity 23. In this embodiment the gaps provide a route for components such as water vapour to enter inner cavity 23 from the outer cavity 21, 22 on the side of which a fire originates. The circulation of water vapour in inner cavity 23 provides further cooling advantages. In an alternative embodiment, inner cavity 23 may contain a reinforcing material such as basalt mesh which can improve the stability of the frame.

FIG. 4 illustrates a cross sectional view of another embodiment of an elongate part of a fire resistant glazing frame 30. Part 30 is the same as part 1 shown in FIG. 1 except that in the embodiment of FIG. 4 the inner cavity 33 is thicker and contains a five layer arrangement of alternating layers of material of the present invention 34, 35. Material 34 also fills outer cavities 31, 32. The layers in the inner cavity 33 alternate from the side adjacent outer cavity 31 to the side adjacent outer cavity 32. The two layers of inner cavity 33 that are adjacent outer cavities 31, 32, and the central layer of inner cavity 33 are composed of a material 35 that is different to material 34 (which fills outer cavities 31, 32 and provides the material for the remaining two layers of inner cavity 33). This arrangement enables the rate of heat transfer through the frame to be further controlled. Also, material 35 may comprise a porous structure that can store water vapour that may be released by material 34 in the event of a fire. In this case, material 35 can act like a sponge, retaining the water in the system to increase its cooling properties. In an alternative embodiment, each of the three layers of inner cavity 33 that are composed of material 35 may contain or be replaced by a reinforcing material such as basalt mesh.

### EXAMPLES

Samples were prepared in accordance with the amounts shown in Tables 1-3 below. The aqueous potassium silicate (Examples 1 and 2), sodium silicate 1 (Example 3) or sodium silicate solution (56% wt water) (Examples 4 and 5) was placed in a container. In the case of Example 3, sodium silicate 2 (50% by weight water) was prepared by mixing 50% wt NaOH solution (50% wt water) with 50% wt silica sol (50% wt water). Next the Ca(OH)₂ was dispersed in sodium silicate 2 before adding the resultant mixture to sodium silicate 1 in the container under stirring. This approach prevents the Ca(OH)₂ reacting instantly with sodium silicate 1.

For Examples 1, 2, 4 and 5 the solid components (apart from the hollow glass microspheres and the basalt mesh) were mixed together and added to the container under stirring. For Example 3, the remaining solid components were mixed together and added to the container under stirring. The remaining liquids (e.g. glycerol and/or water, dependent on the components for each example) were then added into the mixture followed by hollow glass microspheres (Examples 1, 2 and 4). Hollow glass microspheres were added later because of their lack of mechanical stability which means that excessive stirring should be avoided. The mixture was then poured into a mould (resembling a baking tray) and shook to remove any air bubbles. The mixture was then dried at 60° C. for 2-3 hours depending on the particular example.

In the case of incorporating basalt mesh into Example 1, half of the mixture was first poured into the tray. After hardening the mixture a layer of mesh was placed on the plate of material and then the second half of the mixture was poured over the mesh. The mesh was first soaked in the mixture (because the mesh does not have high wetability) before adding to the first hardened half of the mixture, and to remove any trapped air by spreading out the mesh before the second half of the mixture is added. After cooling the mould was removed and the “plate” of material was dried further on a grating.

As detailed previously, it is of course possible to use a frame such as a glazing frame as a mould. This has the advantage that difficult shapes can be easily attained by simply filling a frame which avoids the need to subsequently remove a mould.

Finally the material may be sawed into the appropriate dimensions and drilled if necessary. In some embodiments it is possible to sculpt the final product into a desired shape under moderate heat.

TABLE 1
Amounts of the components present in the mixtures
used to prepare the materials of Examples 1 and 2
according to the invention, and the dimensions of said materials.

| | Example 1 | | Example 2 | |
|---|---|---|---|---|
| Component | Amount | | | |
| Potassium silicate solution | 9.9 | kg | 10.55 | kg |
| (48% wt water) | | | | |
| AlPO₄ | 1.76 | kg | 2.11 | kg |
| Al(OH)₃ | 12.32 | kg | 7.5 | kg |
| Wollastonite | 0.88 | kg | 1.32 | kg |
| MgSO₄ • 7H₂O | 1.76 | kg | — | |
| Silica gel | — | | 10 | kg |
| Water | 1.1 | kg | 2.11 | kg |
| Glycerol (86% wt in water) | 1.1 | kg | — | |
| NaHCO₃ | 0.4 | kg | — | |
| Hollow glass microspheres | 1.0 | kg | 1.0 | kg |

| | | |
|---|---|---|
| Basalt mesh | 1 layer | — |
| Dimensions of resultant materials | 63 × 130 × | 63 × 130 × |
| | 2.3 cm | 2.3 cm |

TABLE 2
Amounts of the components present
in the mixture used to prepare the material
of Example 3 according to the invention.
Example 3

| Component | Amount [g] |
|---|---|
| Al(OH)₃ | 4340 |
| Sodium silicate 1 | 2170 |
| (57% wt water) | |
| Silica Sol | 430 |
| Paper | 230 |
| Ca(OH)₂ | 70 |
| Sodium silicate 2 | 430 |
| (50% wt water) | |

TABLE 3
Amounts of the components present in the mixtures used
to prepare the materials of Examples 4 and 5 according
to the invention, and the dimensions of said materials.

| | Example 4 | | Example 5 | |
|---|---|---|---|---|
| Component | Amount | | | |
| sodium silicate solution (56% wt water) | 32 | kg | 28 | kg |
| AlPO₄ | 5 | kg | 5 | kg |
| Al(OH)₃ | | | 30 | kg |
| Wollastonites | 3 | kg | 2.5 | kg |
| Organic Polymer (styrole-acrylic | — | | 7 | kg |
| acid-ester copolymer) | | | | |
| Water | 1.1 | kg | 2.11 | kg |

| | | | |
|---|---|---|---|
| Hollow glass microspheres | 7.0 | kg | — |

| | | |
|---|---|---|
| Dimensions of resultant materials | 63 × 130 × | 63 × 130 × |
| | 6 cm | 7 cm |

The materials of Examples 1-3 and 5 were used as inserts for fire resistant glazing frames in fire tests according to the EI 30 standard using an oil oven. Pilkington Pyrostop® 30-10 fire resistant glazings (dimensions 15 mm×790 mm×790 mm), which are known to pass the EI 30 test, were used for these tests. The frames were 60 mm wide and 15 mm deep around the entire periphery of the glazings. Under the standard conditions of the fire test the temperature of the frame was monitored by 8 sensors spaced around the surface of the frame. To pass the EI 30 test, none of the sensors is allowed to detect a temperature change of greater than 180K in the first 30 minutes of the test. The tests were carried out at a room temperature of 25° C. therefore to pass the tests the sensors must not have detected a temperature of greater than 205° C.

Inserts with the dimensions 18 cm×35 cm in various lengths were prepared from the materials of Examples 1-3 and 5. The inserts of these examples were slotted into separate frames surrounding the glazings as detailed above and tested in accordance with the EI 30 fire test.

FIG. 5 shows the plots of the temperature detected by each of the eight thermo elements (sensors) as a function of time when using the inserts of Example 1 (M1-8 are the plots for the eight sensors) in a frame in accordance with FIG. 1. None of the eight sensors had detected a temperature even close to 150° C., let alone 205° C., by the 30 minute point. Therefore the inserts of Example 1 passed the EI 30 fire test easily. In the graph of FIG. 5 there is no defined plateau of the plots during the fire test which is indicative of cooling agents that take effect at higher temperatures. Therefore these inserts can be used in powder coating processes.

FIG. 6 shows the plots of the temperature detected by each of the eight frame sensors as a function of time when using the inserts of Example 2 (M1-8 are the plots for the eight sensors) in a frame in accordance with FIG. 2. Again, none of the eight sensors had detected a temperature as high as 150° C., never mind 205° C., by the 30 minute point. Therefore the inserts of Example 2 also passed the EI 30 fire test easily. The inserts of Example 2 exhibit an extended cooling effect around 13-22 minutes of the test whereby the temperature of the frame is maintained at or below 100° C., hence the plots plateau during this period. The inserts of Example 2 contain greater amounts of water and cooling agents that decompose, releasing a cooling liquid, at relatively low temperatures of from around 90° C. to 180° C. These inserts are particularly useful for situations that require extensive cooling at lower temperatures, e.g. if gas bottles or computer devices are present.

FIG. 7 shows the plot of the average temperature detected by the eight frame sensors as a function of time when using the inserts of Example 3. The average temperature that the eight sensors had detected was around 150° C. by the 30 minute point. None of the sensors detected a temperature of greater than 205° C. Therefore the inserts of Example 3 also passed the EI 30 fire test easily. The inserts of Example 3 were elastic under moderate heat which meant that they could be sculpted into the desired form. This characteristic is useful for situations where the insert is required to fit in an unusually shaped frame.

Example 4 concerns a material with a high content of isolating agent which, due to its thermal insulation properties, is particularly suited to inner cavities (i.e. core cavities of a frame, wall or door comprising at least three cavities).

Example 5 relates to a material with a high content of cooling agent which makes it particularly suited to outer cavities (i.e. cavities of a frame, wall or door adjacent the fireside surfaces of the frame, wall or door) where cooling properties are desired. FIG. 8 shows the plots of the temperature detected by each of the eight frame sensors as a function of time when using the inserts of Example 5 (M1-8 are the plots for the eight sensors). One of the eight sensors detected a temperature of around 160° C. by the 30 minute point but the other sensors detected far lower temperatures. Therefore the inserts of Example 5 also passed the EI 30 fire test easily. The inserts of Example 5 bear similarities with those of Example 2 in that they also exhibit an extended cooling effect at around 12-24 minutes of the test whereby the temperature of the frame is maintained at or below 100° C.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1-34. (canceled)

35. A fire resistant composite material comprising:
a matrix comprising one or more liquid and one or more of silicates of the elements of Groups 1, 2, 13 and/or 14 of the periodic table, phosphates of the elements of Group 13 of the periodic table and/or organo compounds of the elements of Group 13 of the periodic table; and
a cooling agent comprising one or more of MOH, M2O, M2SO4, MHSO4, M(PO3)3, MxH3-xPO4 (where x=0 to 3), M2CO3, MHCO3, borates such as M2[B4O5(OH)4] (where M=Li, Na, K, and/or NH4), M′(OH)2, M′O, M′CO3, M′SO4, M′PO4 (where M′=Ca, Mg, Ba, Sr, and/or Fe), Al(OH)3, Fe(OH)3, Si(OH)4, SiO(OH)2, FeO(OH), AlO(OH), salts thereof, silica gel, molecular sieves, glycols, polyols, non-flammable organic solvents, dried alkali metal silicates and/or saccharides; and/or an isolating agent comprising one or more of hollow microspheres, foam microspheres, glass flakes, ceramic flakes, wood chips and/or cellulose chips.

36. A mixture for the preparation of a fire resistant composite material comprising:
a matrix comprising one or more liquid and one or more of silicates of the elements of Groups 1, 2, 13 and/or 14 of the periodic table, phosphates of the elements of Group 13 of the periodic table and/or organo compounds of the elements of Group 13 of the periodic table; and
a cooling agent comprising one or more of MOH, M2O, M2SO4, MHSO4, M(PO3)3, MxH3-xPO4 (where x=0 to 3), M2CO3, MHCO3, borates such as M2[B4O5(OH)4] (where M=Li, Na, K, and/or NH4), M′(OH)2, M′O, M′CO3, M′SO4, M″PO4 (where M′=Ca, Mg, Ba, Sr, and/or Fe), Al(OH)3, Fe(OH)3, Si(OH)4, SiO(OH)2, FeO(OH), AlO(OH), salts thereof, silica gel, molecular sieves, glycols, polyols, non-flammable organic solvents, dried alkali metal silicates and/or saccharides; and/or
an isolating agent comprising one or more of hollow microspheres, foam microspheres, glass flakes, ceramic flakes, wood chips and/or cellulose chips.

37. The material according to claim 35, wherein the material comprises at least 5% by weight of one or more liquid, but at most 50% by weight of one or more liquid based on the total weight of the material, wherein the one or more liquid comprises water.

38. The material according to claim 35, wherein the one or more of silicates of the elements of Groups 1, 2, 13 and/or 14 of the periodic table, phosphates of the elements of Group 13 of the periodic table and/or organo compounds of the elements of Group 13 of the periodic table are present at a total concentration of at least 5% by weight, but at most 40% by weight based on the total weight of the material.

39. The material according to claim 35, wherein the one or more silicates of the elements of Groups 1, 2, 13 and/or 14 of the periodic table comprise layer silicates and/or comprise grog, mullite and/or bentonite.

40. The material according to claim 35, wherein the silicates of the elements of Group 1 of the periodic table are sodium silicates and/or potassium silicates, wherein the silicates of the elements of Group 2 of the periodic table are magnesium silicates and/or calcium silicates, wherein the silicates of the elements of Group 13 of the periodic table are borosilicates and/or aluminium silicates, and wherein the silicates of the elements of Group 14 of the periodic table are organosilicates.

41. The material according to claim 35, wherein the phosphates of the elements of Group 13 of the periodic table are boron phosphates and/or aluminium phosphates.

42. The material according to claim 35, wherein the organo compounds of the elements of Group 13 of the periodic table are organoboron and/or organoaluminium compounds.

43. The material according to claim 35, wherein the matrix further comprises one or more of Ca(Hal)2, Mg(Hal)2 (where Hal=F, Cl, Br, or I), aluminates, zinc compounds, zirconium compounds, titanium compounds, silica-sol, laponite, organic compounds, acrylates, latex, vinyl-acetates, polyvinyl polymers, polyethanolate, polyurethane, cotton, celluloses, epoxy resins, phenolic resins, polycarboxylate ethers and/or nylon; paper; mesh, fabric, tapes and/or fibres of basalt, glass, ceramic, organic polymers, cotton and/or fibreglass; materials derived from jute, flax, hemp and/or cellulose fibres, textile materials, gauze bandages, siloxanes, and/or tetraethyl orthosilicate (TEOS), and/or silicones.

44. The material according to claim 43, wherein at least one organic compound is a surfactant.

45. The material according to claim 35, wherein the cooling agent, not taking into account any associated water of crystallisation, is present at a total concentration of at least 15% by weight, but at most 70% by weight based on the total weight of the material.

46. The material according to claim 35, wherein the cooling agent, not taking into account any associated water of crystallisation, is present at a total concentration of at least 35% by weight, but at most 95% by weight based on the total weight of the material.

47. The material according to claim 35, wherein the cooling agent comprises
a first cooling agent comprising one or more of salt hydrates, silica gel, molecular sieves, alkali-borates, zinc-borates, organo-zinc-borates, glycols, polyols, non-flammable organic solvents and/or dried alkali metal silicates; and/or
a second cooling agent comprising one or more of Al(OH)3, AlO(OH), Zn(OH)2, Fe(OH)2, Fe(OH)3, FeO(OH), Ca(OH)2, and/or Mg(OH)2.

48. The material according to claim 35, wherein the silica gel has been produced by reacting an alkali metal silicate with an acid.

49. The material according to claim 35, wherein the isolating agent comprises one or more of hollow glass microspheres, foam microspheres, hollow ceramic microspheres and/or hollow polymer microspheres.

50. The material according to claim 35, wherein the cooling agent is encapsulated in one or more foil package.

51. The material according to claim 35, wherein, when present in the material, said isolating agent is present at a total concentration of at least 0.5% by weight, but at most 50% by weight based on the total weight of the material.

52. The material according to claim 35, further comprising one or more retarder selected from the group consisting of borax, D(−) tartaric acid and/or L(+) tartaric acid.

53. The material according to claim 35, wherein the material is encapsulated in a tubing.

54. The material according to claim 35, wherein the material is in the form of a layer, rod, tube, plate or block.

55. An insert for a fire resistant glazing frame, wall and/or door, wherein the insert incorporates the material of claim 35.

56. An insert for a fire resistant glazing frame, wall and/or door, wherein the insert comprises more than one material according to claim 35, wherein the insert comprises at least two layers, and wherein where any layers are in direct contact with each other, said layers that are in direct contact comprise different materials.

57. An insert for a fire resistant glazing frame, wall and/or door, wherein the insert incorporates one or more materials according to claim 35 encapsulated by a different material according to claim 35.

58. The insert according to claim 55, wherein the insert is encapsulated in metal, plastic and/or fibreglass.

59. A fire resistant article selected from the group consisting of a glazing frame, wall, bulkhead, blind and/or door that incorporates the insert of claim 55.

60. The fire resistant article according to claim 59 comprising at least one cavity.

61. The fire resistant article according to claim 59 comprising at least three cavities, one inner and two outer cavities, wherein an outer insert incorporated in an outer cavity comprises at least 40% by weight of cooling agent and at most 20% by weight of isolating agent, and wherein an inner insert incorporated in an inner cavity comprises at least 40% by weight of isolating agent and at most 20% by weight of cooling agent.

62. A fire resistant glazing assembly comprising at least one fire resistant glazing attached to a fire resistant glazing frame according to claim 59.

63. A fire resistant article comprising at least one cavity,
wherein said at least one cavity is at least partially separated from an external environment by a housing,
wherein said at least one cavity contains a first fire resistant material and
i) a void and/or
ii) a second fire resistant material.

64. The article according to claim 63, wherein said at least one cavity is completely separated from an external environment by a housing.

65. The article according to claim 63, wherein said housing comprises a metal, fibreglass and/or plastic housing.

66. The article according to claim 63, wherein the housing comprises a plurality of sections, wherein at least one section of the housing comprises the first fire resistant material, wherein said first fire resistant material separates the inner cavity from an external environment at said section.

67. The article according to claims 63, wherein said second fire resistant material comprises one or more of hollow microspheres and/or foam microspheres.
